(19) United States
(12) Patent Application Publication
(10) Pub. No.: US 2022/0339649 A1
(43) Pub. Date: Oct. 27, 2022

(54) HIGH PRESSURE WATER JET GUN

(71) Applicant: TECOMEC S.R.L., REGGIO EMILIA (RE) (IT)

(72) Inventor: ENRICO CIGARINI, Reggio Emilia (IT)

(21) Appl. No.: 17/645,478

(22) Filed: Dec. 22, 2021

(30) Foreign Application Priority Data
Apr. 21, 2021 (IT) 102021000010073

(51) Int. Cl. B05B 9/01; B05B 12/00

(52) U.S. Cl. CPC B05B 9/01; B05B 12/0026

(57) ABSTRACT

High pressure water jet gun (1) comprising: a dispensing body (6); a gripping body (13) connected to the dispensing body (6); an actuation member (10) reversibly movable between an activation position, wherein it is active on a shutter member (9) in order to at least partly cause an open condition, and a rest position, corresponding to a closed configuration of the shutter member (9); a blocking means (16) reversibly movable between a safety configuration, in which it is active on the actuation member (10) to prevent a passage from the rest position to the activation position, and a working configuration, wherein it enables a reversible passage of the actuation member (10) between the rest position and the activation position. In particular, the blocking means (16) comprises an activation element (17) mounted on the dispensing body (6) and slidably reversibly movable with respect to the dispensing body (6) between a retracted position, corresponding to the safety configuration of the blocking means (16), and an advanced position, corresponding to the working configuration of the blocking means (16).

The present invention relates to a high pressure water jet gun.

The definition “high pressure water jet” refers herein to a machine which, through the generation of a water jet at high pressure, enables the removal of incrustations and impurities from surfaces of various kinds thanks to the high impact energy on the surface.

A high pressure water jet machine generally comprises a high pressure water pump, an electric motor and a gun for dispensing the water jet.

In particular, the high pressure imparted to the water jet results in the high kinetic energy thereof which enables the jet to easily remove the impurities present on the surface to be cleaned.

Disadvantageously, the kinetic energy imparted to the jet is so high that, if it hits a person's body, it can cause injuries of varying severity.

Therefore, safety systems have been developed which aim to prevent the involuntary action of the gun for dispensing the water jet.

Such systems require the use of both hands for deactivating the safety system so as to enable a consequent activation of the gun.

In particular, the user grips the gun with a first hand and with a second hand deactivates the safety system, generally arranged in proximity to the grip for the first hand, so as to enable the dispensing of the fluid.

However, during use of the gun the user grips the gun with the first hand and with the second hand holds a portion of the gun proximal to the fluid dispensing nozzle so as to be able to spread the force exerted by the jet between both limbs and so as to be able to appropriately direct the jet of fluid towards the surface to be cleaned.

Therefore, the interface with the safety system is particularly inconvenient for the user who must move his/her second hand from the portion of gun proximal to the dispensing nozzle losing accuracy in the fluid dispensing direction during the moments following the deactivation of the safety system and strongly straining the hand gripping the gun.

Furthermore, such repeated complicated movement during use of the high pressure water jet machine causes increased strain for the user and, inevitably, longer times for the cleaning process.

In this context, the technical task underpinning the present invention is to provide a high pressure water jet gun which obviates the drawbacks in the prior art as described above.

In particular, it is an object of the present invention to provide a high pressure water jet gun that enables the use of a high pressure water jet machine to be simplified for a user.

A further object of the present invention is that of providing a high pressure water jet gun able to ensure a high degree of safety for the user during the different operating conditions.

A further aim of the present invention is to provide a high pressure water jet gun that has improved ergonomics with respect to prior-art devices.

The stated technical task and specified objects are substantially achieved by a high pressure water jet gun comprising the technical features disclosed in one or more of the appended claims.

The dependent claims correspond to possible embodiments of the invention.

Further features and advantages of the present invention will become more apparent from the following indicative and therefore non-limiting description of a preferred but not exclusive embodiment of a high pressure water jet gun as illustrated in the appended drawings in which:

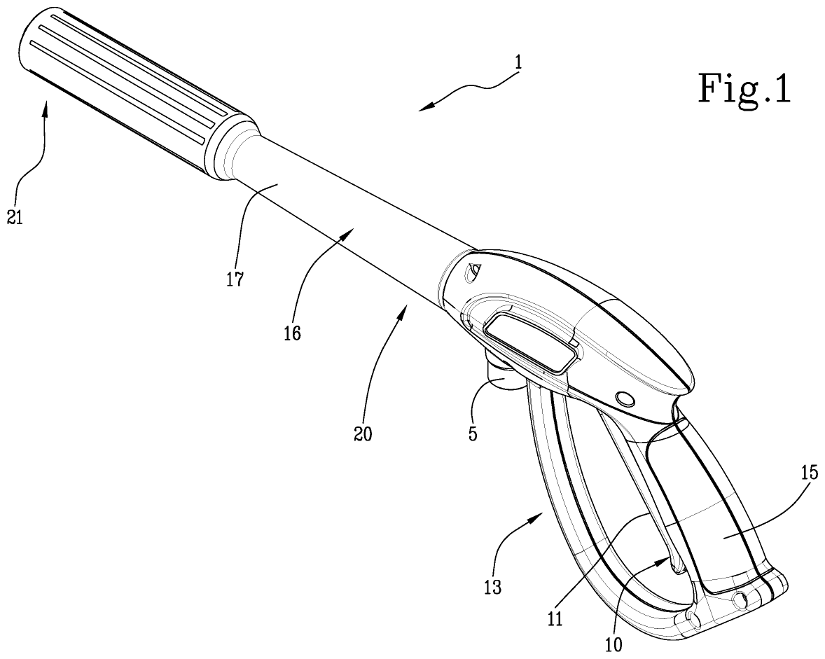

FIG. 1 is a perspective view of a high pressure water jet gun in accordance with a possible embodiment of the present invention;

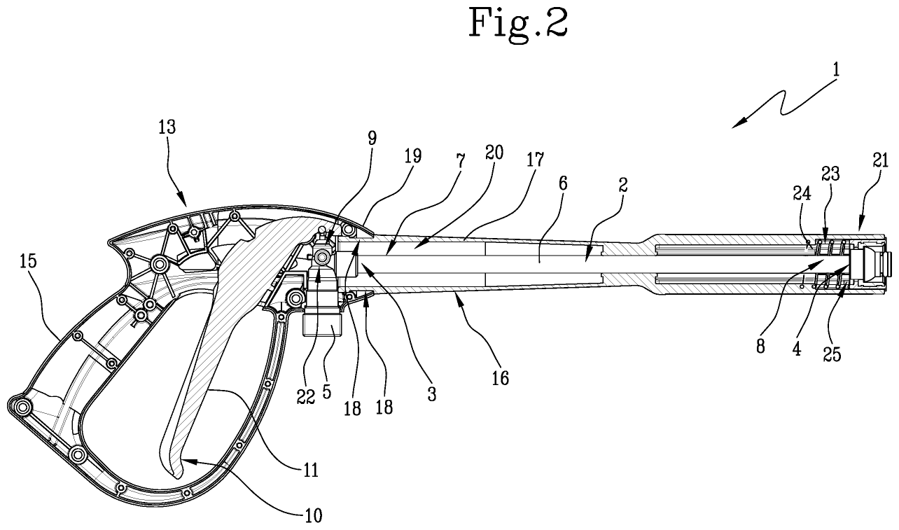

FIG. 2 is a partial section side view of the high pressure water jet gun of FIG. 1 according to a possible operating configuration;

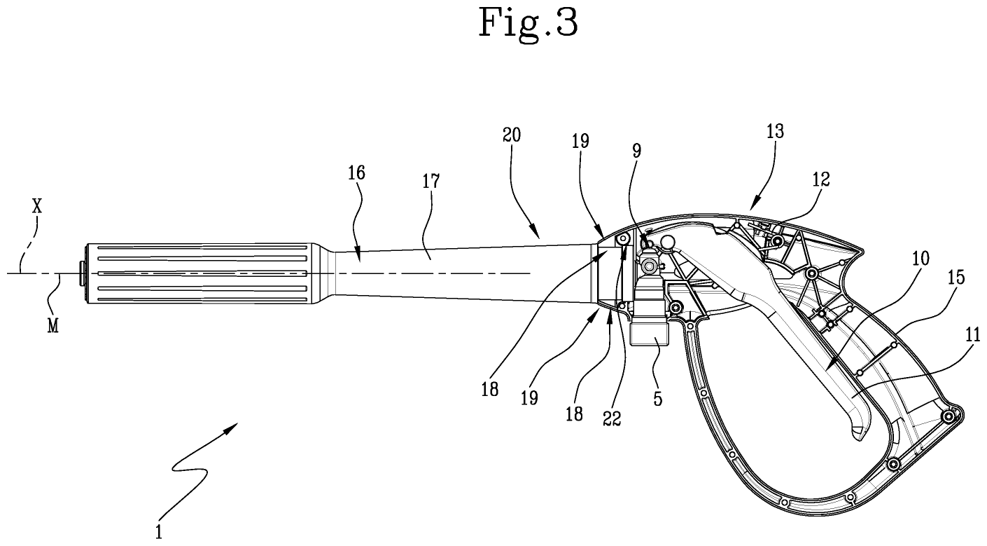

FIG. 3 is a side view of a portion of the high pressure water jet gun of FIG. 1 according to a further possible operating configuration.

With reference to the accompanying drawings, the reference number 1 has been used to generally designate a high pressure water jet gun, which will be referred to here as gun 1.

The gun 1 defines at least one conduit 2 extending between an inlet opening 3 and an outlet opening 4 in order to enable passage of at least one fluid, preferably water.

The gun 1 comprises at least one connector 5 adapted to place the inlet opening 3 in fluid communication with an external supply unit (not illustrated in the appended figures).

Furthermore, the gun 1 comprises a dispensing body 6 at least partially defining the conduit 2.

The dispensing body 6 has at least the aforementioned outlet opening 4 to enable the dispensing of the aforesaid fluid.

Preferably, the dispensing body 6 has a substantially tubular conformation extending between a first end 7 and a second end 8 along a prevalent extension direction “X”.

In accordance with a possible embodiment and as shown in the appended figures, the outlet opening 4 may be arranged at the second end 8.

Furthermore, the opening inlet 3 can be arranged at the first end 7 of the dispensing body 6.

According to further possible embodiments not illustrated in the appended figures, the inlet opening 3 and/or the outlet opening 4 may be located in a different way from what has been previously described without altering the inventive concept underpinning the present invention.

The gun 1 further comprises a shutter member 9 adapted to enable or inhibit a passage of the fluid through the conduit 2.

In particular, the shutter member 9 is reversibly movable between an open condition, wherein it enables passage of the fluid through the conduit 2, and a closed condition, wherein it inhibits passage of the fluid through the conduit 2.

In other words, the shutter member 9 enables the gun 1 to dispense fluid during the opening condition and prohibits it during the closed condition.

As illustrated in the appended figures, the gun 1 further comprises an actuation member 10 reversibly movable between an activation position (FIG. 3), wherein it is active on the shutter member 9 in order to at least partly cause an open condition of the shutter member 9, and a rest position (FIG. 2), corresponding to a closed condition of the shutter member 9.

Preferably, the actuation member 10 comprises an actuation lever 11 activatable by a user to reversibly switch the actuation member 10 between the rest position and the actuation position.

Furthermore, the gun 1 can comprise at least one elastic body 12 active on the actuation member 10 to promote a movement from the actuation position to the rest position.

The gun 1 further comprises a support body 13 connected to the dispensing body 6.

In accordance with a possible embodiment and as shown in the appended figures, the support body 13 may be connected to the dispensing body 6 at the first end 7.

In particular, the aforementioned first end 7 may be at least partially contained in the support body 13 so that the interface between the support body 13 and the dispensing body 6 is protected by accidental stresses that can lead to failures and, therefore, to a reduced operating life of the gun 1. Advantageously, the support body 13 can define a housing 14 adapted to at least partially contain the aforementioned connector 5 at least during an operating configuration of the gun 1 so as to guarantee a highly efficient coupling between the connector 5 and the gun 1.

The support body 13 defines a grip 15 adapted to be gripped by a user to enable a movement of the gun 1 during at least one operating configuration.

Advantageously, the gun 1 comprises a blocking means 16 which enables the level of safety during use of the gun 1 to be increased.

The blocking means 16 is reversibly movable between a safety configuration (FIG. 2), in which it is active on the actuation member 10 to prevent a passage of the actuation member 10 from the rest position to the activation position, and a working configuration (FIG. 3), wherein it enables a reversible passage of the actuation member 10 between the rest position and the activation position.

Furthermore, the blocking means 16 comprises a manual activation element 17 activatable by a user for reversibly switching said blocking means 16 between the safety configuration and the working configuration.

The activation element 17 is mounted at least partially on the dispensing body 6.

In particular, the activation element 17 is slidably reversibly movable with respect to the dispensing body 6 between a retracted position (FIG. 2), corresponding to the safety configuration of the blocking means 16, and an advanced position (FIG. 3), corresponding to the working configuration of the blocking means 16.

In accordance with a possible embodiment and as shown in the appended figures, the activation element 16 is at least partially inserted into the support body 13.

Advantageously, the activation element 17 can be reversibly movable with respect to the support body 13 between a maximum insertion position, corresponding to the retracted position of the activation element 17 with respect to the dispensing body 6, and a minimum insertion position, corresponding to the advanced position of the activation 17 with respect to the dispensing body 6.

In this way, the user can activate the gun 1 through a mutual distancing motion between the activation element 17 and the support body 13.

It is underlined that during a rest condition high pressure water jet guns are generally arranged resting substantially aligned along a vertical axis. Very advantageously, such type of activation increases the safety of the gun 1 as it prevents accidental activations due for example to the action of the force of gravity, which by acting on the masses of the components of the gun 1 itself during the rest condition can cause a passage of the blocking means 16 from the safety configuration to the working configuration, or accidental impacts.

Furthermore, the activation element 17 can comprise at least one undercut 18 operatively connected to a respective guide portion 19 of the support body 13 to define a sliding guide adapted to allow a relative movement between the activation element 17 and the dispensing body 6 and/or the support body 13.

Advantageously, the grip 15 and the activation element 17 can be configured to be gripped, preferably contemporaneously, respectively by a first hand of a user and by a second hand of a user in such a way that, in a condition of use of the gun 1, the user does not have to detach the first hand and/or the second hand respectively from the grip 15 and/or the activation element 17 in order to switch the blocking means 16 between the safety configuration and the working configuration.

In particular, the activation element 17 can define a gripping portion grippable by a user for activating blocking means.

Such gripping portion can have rubber elements and/or with an increased friction coefficient (not shown in the appended figures) adapted to promote the activation by the user limiting the possibility of accidental slipping between the user's hand and the activation element 17.

According to a possible embodiment and as illustrated in the appended figures, the activation element 17 has a substantially tubular conformation extending along an extension direction that is parallel, preferably coincidental, with the aforementioned prevalent extension direction “X”.

Furthermore, the activation element 17 can extend between a first end portion 20, arranged substantially at the inlet opening 3 of the conduit 2, and a second end portion 21, substantially arranged at the outlet opening 4 of the conduit 2.

Preferably, the activation element 17 can be substantially fitted onto the dispensing body 6.

In particular, the activation element 17 can be reversibly translatable with respect to the dispensing body 6 at least partially along a movement direction “M”, preferably parallel to the prevalent extension direction “X”.

As shown in the appended figures, the activation element 17 can define an abutment portion 22 adapted to be activated on the actuation member 10 during the safety configuration of the blocking means 16 to prevent a passage thereof from the rest position to the activation position.

Preferably, the abutment portion 22 is defined by a portion of the first end portion 20 of the activation element 17.

Advantageously, the gun 1 can comprise at least one elastic return means 23 active on the blocking means 16 to promote a movement thereof from the working configuration to the safety configuration.

In this way, the blocking means 16 can return to the safety configuration after use of the gun 1 without any need for the intervention of the user.

According to a purely exemplifying and non-limiting embodiment of the present invention, the elastic return means 23 comprises a helix spring 24 fitted onto the dispensing body 6.

Such helix spring 24 is active on respective shoulders 25 of the activation element 17 and of the dispensing body 6 and/or constrained to the activation element 17 and/or to the dispensing body 6 to cause a movement of the activation element 17 from the advanced position to the retracted position.

It is therefore observed that the present invention achieves the proposed aims by providing a high pressure water jet gun able to simplify the use of a high pressure water jet machine for a user thanks to the presence of an activation element mounted on the dispensing body and slidably movable reversibly with respect to the dispensing body between a retracted position, corresponding to said safety configuration of the blocking means, and an advanced position, corresponding to the working configuration of the blocking means.

Advantageously, the present invention makes available a gun with improved ergonomics with respect to devices of the prior art such as to make the use of the high pressure water jet simpler and less tiring for a user.

1. A high pressure water jet gun (1) defining at least one conduit (2) extending between an inlet opening (3) and an outlet opening (4) in order to enable passage of at least one fluid and comprising:
at least one connector (5) adapted to place said inlet opening (3) in fluid communication with an external supply unit;
a dispensing body (6) at least partly defining said conduit (2) and having at least said outlet opening (4) to enable a dispensing of the fluid;
a support body connected to said dispensing body (6) and defining a grip (15), said grip (15) being configured to be gripped by a user to enable a movement of said gun (1) during at least one operating configuration;
a shutter member (9) to enable or inhibit a passage of the fluid through said conduit (2), said shutter member (9) being reversibly movable between an open condition, wherein it enables passage of the fluid through said conduit (2), and a closed configuration, wherein it inhibits passage of the fluid through said conduit (2);
an actuation member (10) reversibly movable between an activation position, wherein said actuation member (10) is active on said shutter member (9) in order to at least partly cause an open condition of said shutter member (9), and a rest position, corresponding to a closed configuration of said shutter member (9);
a blocking means (16) reversibly movable between a safety configuration, in which the blocking means (15) is active on said actuation member (10) to prevent a passage of said actuation member (10) from said rest position to said activation position, and a working configuration, wherein the blocking means (15) enables a reversible passage of said actuation member (10) between said rest position and said activation position;
wherein said blocking means (16) comprise a manual activation element (17) activatable by a user so as to reversibly switch said blocking means (16) between said safety configuration and said working configuration, said activation element (17) being mounted on said dispensing body (6) and slidably reversibly movable with respect to said dispensing body (6) between a retracted position, corresponding to said safety configuration of said blocking means (16), and an advanced position, corresponding to said working configuration of said blocking means (16).

2. The high pressure water jet gun according to claim 1, wherein said activation element (17) is at least partly inserted in said support body; and wherein said activation element (17) is reversibly movable with respect to said support body between a maximum insertion position, corresponding to said retracted position of said activation element (17) with respect to said dispensing body (6), and a minimum insertion position, corresponding to said advanced position of said activation element (17) with respect to said dispensing body (6).

3. The high pressure water jet gun according to claim 1, wherein said grip (15) and said activation element (17) are configured to be gripped, preferably contemporaneously, respectively by a first hand of a user and by a second hand of a user in such a way that, in a condition of use of said gun (1), the user does not have to detach said first hand and/or said second hand respectively from said grip (15) and/or said activation element (17) in order to switch said blocking means (16) between said safety configuration and said working configuration.

4. The high pressure water jet gun according to claim 1, wherein said activation element (17) defines a gripping portion grippable by a user to activate said blocking means (16).

5. The high pressure water jet gun according to claim 1, wherein said dispensing body (6) has a substantially tubular conformation extending along a main extension direction (X); and wherein said activation element (17) has a substantially tubular conformation extending along an extension direction (X) that is parallel, preferably coincidental, with said main extension direction (X) between a first end portion (20), arranged substantially at said inlet opening (3) of said conduit (2), and a second end portion (21), arranged substantially at said outlet opening (4) of said conduit (2), said activation element (17) being fitted on said dispensing body (6) and at least partly reversibly translatable with respect to said dispensing body (6) along a movement direction (M) parallel to said main extension direction (X).

6. The high pressure water jet gun according to claim 1, wherein said activation element (17) defines an abutment portion (22) adapted to be activated on said actuation member (10) during said safety configuration of said blocking means (16) to prevent a passage thereof from said rest position to said activation position.

7. The high pressure water jet gun according to claim 5, wherein said activation element (17) defines an abutment portion (22) adapted to be activated on said actuation member (10) during said safety configuration of said blocking means (16) to prevent a passage thereof from said rest position to said activation position, wherein said abutment portion (22) is defined by a portion of said first end portion (20) of said activation element (17).

8. The high pressure water jet gun according to claim 1, wherein said activation element (17) comprises at least one undercut (18) operatively connected to a respective guide portion (19) of said support body to define a sliding guide adapted to allow a relative movement between said activation element (17) and said dispensing body (6) and/or said support body.

9. The high pressure water jet gun according to claim 1, comprising elastic return means (23) active on said blocking means (16) to cause a movement of said blocking means (16) from said working configuration to said safety configuration.

10. The high pressure water jet gun according to claim 9, wherein said elastic return means (23) comprises a helix spring (24) fitted on said dispensing body (6) and active on respective shoulders (25) of said activation element (17) and of said dispensing body (6) to cause a movement of said activation element (17) from said advanced position to said retracted position.

11. The high pressure water jet gun according to claim 1, wherein said actuation member (10) comprises an actuation lever (11) activatable by a user to reversibly move said actuation member (10) between said rest position and said actuation position.

12. The high pressure water jet gun according to claim 1, comprising at least one elastic body (12) active on said actuation member (10) to cause a movement of said actuation member (10) from said actuation position to said rest position.
